(19) United States
(12) Patent Application Publication
(10) Pub. No.: US 2013/0055056 A1
(43) Pub. Date: Feb. 28, 2013

(54) System and Method for Searching Belongings Using Social Graph Information

(71) Applicant: Zaheed Md Shahjahan Sabur, Adliswil (CH)

(72) Inventor: Zaheed Md Shahjahan Sabur, Adliswil (CH)

(73) Assignee: Google Inc., Mountain View, CA (US)

(21) Appl. No.: 13/221,756

(22) Filed: Aug. 30, 2011

(51) Int. Cl. G06F 17/30; G06F 17/00

(52) U.S. Cl. 715/205; 707/769; 707/E17.014

(57) ABSTRACT

A system and machine-implemented method for providing a user with a representation of a belonging according to search criteria, the method including receiving a request from a user of one or more users of a system to search a social graph of belongings according to a search criteria, wherein the social graph of belongings defines an association between each of the one or more users and one or more belongings, each of the belongings corresponding to an item, comparing the one or more belongings associated with each of the one or more users with the search criteria, wherein the search criteria comprises at least one belonging attribute, identifying a belonging based on the comparison, the belonging having the at least one belonging attribute and providing a representation of the belonging for display to the user including providing the user with access to the belonging profile associated with the belonging.

### BACKGROUND

The subject disclosure generally relates to searching for products online, and more specifically to searching for online products that meet criteria.

Social networking users may wish to share their activities related to purchasing of products with their contacts on social networking sites. To do so, these users typically must provide this information in text form, through posts and feeds. Information such as products being on sale, available for giving away, product reviews, as well as users wishing to buy certain products can be shared through these posts and feeds.

However, typically these posts are in text form, and it is difficult to sort and search through the shared information. Thus, a convenient way for allowing a user to search for products may be desirable.

### SUMMARY

The disclosed subject matter relates to a machine-implemented method for providing a first user with a representation of a belonging according to search criteria, the method comprising receiving a request from a first user of one or more users of a system to search a social graph of belongings according to a search criteria, wherein the social graph of belongings defines an association between each of the one or more users and one or more belongings, each of the one or more belongings corresponding to an item. The method further comprising comparing the one or more belongings associated with each of the one or more users according to the social graph of belongings with the search criteria, wherein the search criteria comprises at least one belonging attribute. The method further comprising identifying a belonging of the belongings within the social graph of belongings based on the comparison, the belonging having the at least one belonging attribute and providing a representation of the belonging for display to the first user, wherein the providing the representation of the belonging comprises providing the first user with access to the belonging profile associated with the belonging.

The disclosed subject matter also relates to a system for providing a first user with a list of belongings according to a search criteria, the system comprising one or more processors and a machine-readable medium comprising instructions stored therein, which when executed by the processors, cause the processors to perform operations comprising receiving a request from a first user of one or more users of a system to search a social graph of belongings according to a search criteria, wherein the social graph of belongings defines an association between each of the one or more users and one or more belongings, each of the one or more belongings corresponding to an item. The operations further comprising comparing each of the belongings within the social graph of belongings with the search criteria. The operations further comprising identifying a belonging of the belongings within the social graph of belongings, the belonging meeting the search criteria. The operations further comprising generating a list including a representation of the belonging and at least one of a link to the user associated with the belonging or a link to the belonging and providing the list for display to the first user.

The disclosed subject matter also relates to a machine-readable medium comprising instructions stored therein, which when executed by a machine, cause the machine to perform operations comprising receiving a request from a first user of one or more users of a system to search a social graph of belongings according to a search criteria, wherein the social graph of belongings defines an association between each of the one or more users and one or more belongings, each of the one or more belongings corresponding to an item, wherein each belonging is associated with a belonging profile comprising belonging attributes of the belonging. The operations further comprising comparing the belonging attributes for each of the belongings within the social graph of belongings with the search criteria, wherein the search criteria comprises at least one belonging attribute. The operations further comprising identifying a belonging of the belongings within the social graph of belongings, the belonging having the at least one belonging attribute and providing a representation of the belonging for display to the first user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment, which provides for managing belonging-related information using a social graph of belongings.

FIG. 2 illustrates a flow chart illustrating a process for generating and maintaining a social graph of belongings.

FIGS. 3A and 3B illustrate screen-shots of an example graphical user interface for adding a new belonging to the belongings of a user.

FIG. 4 illustrates a flow chart illustrating a process for generating a belonging-related post and sharing the post with contacts of a user.

FIG. 5 illustrates a flow chart illustrating a process for displaying a belonging-related stream to a user of the system maintaining a social graph of belongings.

FIG. 6 illustrates a flow chart illustrating a process for providing a user with one or more belongings in response to a search request by referencing a social graph of belongings.

FIG. 7 illustrates an exemplary social graph of belongings.

FIG. 8 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

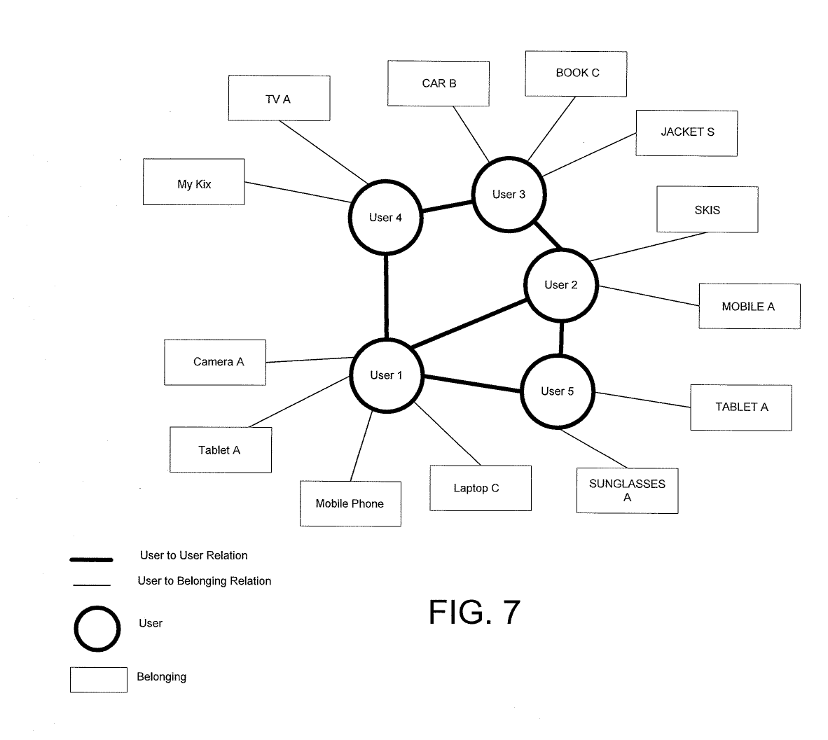

As used herein, “belongings” refer to items owned by a user or items a user has indicated that the user is looking to own, borrow or learn more about. A user's belongings may include items purchased online (e.g., through an internet based retailer), offline (e.g., at regular retail stores), or received as gifts. In accordance with the subject disclosure, a method and a system are provided for building a social graph of belongings of one or more users. In one instance, each user of the system may add one or more belongings, and the system may associate each of the belongings with the user. Thus, in one example of the subject disclosure, a social graph of belongings may include associations between a user and their belongings. In one example, the social graph of belongings may further include associations between users (e.g., by leveraging existing social graphs at one or more remote social networking sites). An exemplary social graph of belongings is described in further detail below with respect to FIG. 7.

In one example, the system may allow users of the system to share activities related to their belonging with their contacts. As used herein, “posts” generally refer to any displayable notification or announcement regarding activities performed with respect to a belonging, including for example comments, replies, announcements, status updates, digital photos, videos or other appropriate electronic information. Activities related to belongings may include adding a belonging, adding reviews regarding a belonging, adding a description regarding the belonging, modifying one or more belonging attributes of a belonging, sharing the belonging, or indicating a state for the belonging.

Users of remote social networking sites may create associations with one another. These associations may be stored within a social graph at each remote social networking site (e.g., maintained at a remote server). Such user associations may be defined on a user-to-user basis, or as a group of users associated through membership within a group. As used herein, “contacts” refer to a user's friends, social circles, groups and other users that the user is associated with, at one or more remote social networking sites.

As used herein, “social circles” are categories to which a user can assign their social networking contacts and better control the distribution and visibility of social networking messages. In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social circles, the user can organize and categorize social networking contacts into various different groupings.

The system may leverage existing social graphs maintained at one or more remote social networking sites to facilitate distribution of posts with contacts of a user. For example, one or more remote social networking sites may maintain a social graph of users and their contacts. The system may access social graphs maintained at these remote social networking sites and retrieve contacts of the users of the system. In one instance, the user may indicate membership at one or more remote social networking sites and provide the system with access to these remote social networking sites, for example, through a token. The contacts retrieved by the system may depend upon the specific privacy settings enforced at each of the remote social networking sites.

The retrieved contacts may further be associated with the user within the social graph of belongings. In one aspect, contacts of the user at one or more social networking sites, which are also users of the system, may be identified and associated with the user within the social graph of belongings maintained by the system.

The system may, upon accessing the remote social networking sites, retrieve information with respect to one or more users of the system and their associated contacts. Using the retrieved contacts, the system can then allow users of the system to share posts related to their belongings with their contacts. The post may then be distributed to the one or more remote social networking sites to be displayed to the user's contacts at the remote social networking site. The system may allow the user to choose specific contacts or groups of contacts at the one or more remote social networking sites with whom the post is shared. In one example, some or all of the remote social networking sites may provide support for selectively sharing posts with one or more contacts of the users.

The system may further provide for tracking the shared posts. In one example, prior to the post being distributed to the one or more remote social networking sites, each post may be assigned a unique identifier to facilitate tracking and control of the post once the post has been distributed either locally or to one or more remote social networking sites. The unique identifier may be associated with a belonging the post is related to and/or a user associated with the specific belonging. In one exemplary instance, the system tracks the post through the unique identifier. For example, the post may be linked with the unique identifier such that after distribution the post may be retrieved and modified using the link, even after the post has be distributed and displayed to contacts.

The system may further provide the users of the system with the ability to search for belongings, and information relating to each belonging, associated with one or more other users of the system (e.g., contacts of a user of the system). In one aspect, each user of the system is able to search within the social graph of belongings according to various search criteria. The system may detect a search request from the first user to search the social graph of belongings for belongings, and/or information relating to belongings, according to specific search criteria.

The search criteria may include one or more belonging attributes of a belonging and/or one or more user attributes of the user associated with the belonging. The search criteria may include belonging attributes stored within a belonging profile of each belonging maintained within the social graph of belongings. The search criteria may identify information regarding the belonging, such as the name of a an item corresponding to a belonging, a category of a belonging, a belonging state of the belonging, the user associated with the belonging maintained within the social graph of belongings and the geographic location of the belonging (e.g., a geographical location of the belonging and/or a geographical location of the user associated with the belonging).

Upon receiving a search request from a user of the system, the system may access all belongings within the social graph of belongings, and compare the search criteria to belonging attributes corresponding to each of the belongings. In one instance, each belonging is associated with a belonging profile storing belonging attributes of the belonging. The user associated with the belonging may further be associated with a user profile storing user attributes of the user. The system may retrieve the belonging profile associated with each belonging and/or the user profile of the user associated with the belonging and compare the search criteria to the belonging attributes defined within the belonging profile, and/or the user attributes of the user associated with the belonging defined within the user profile, to detect one or more belongings meeting the search criteria. The detected belongings may be displayed to the user requesting the search. For each of displayed belongings, the user may be able to access the belonging profile associated with each belonging and get further information concerning the belonging.

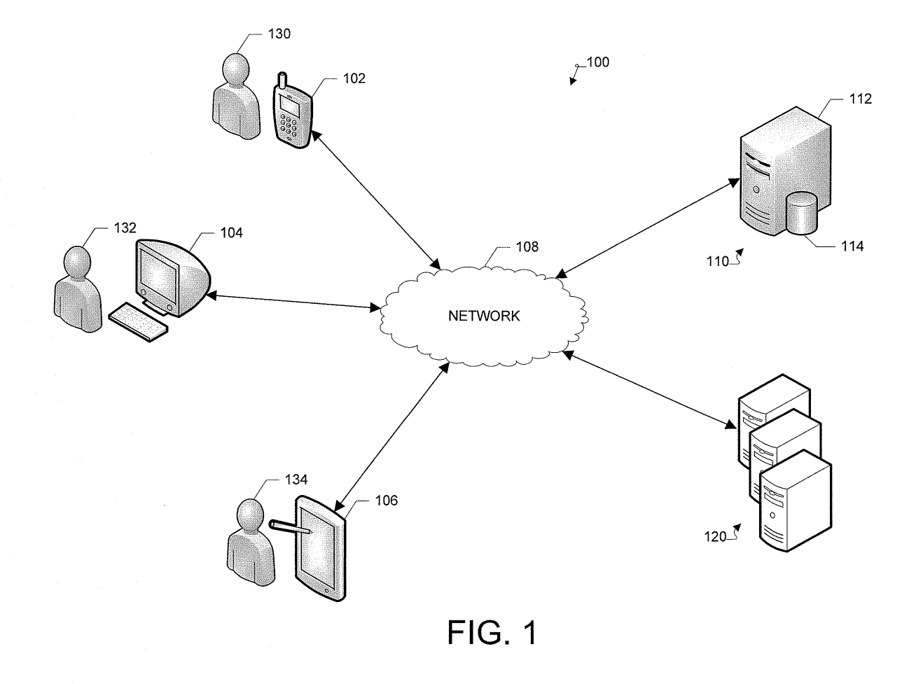

FIG. 1 illustrates an example client-server network environment, which provides for managing belonging-related information using a social graph of belongings. A network environment 100 includes a number of electronic devices 102-106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example embodiments, electronic devices 102-106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In one embodiment, server 110 includes a processing device 112 and a data store 114. Processing device 112 executes computer instructions stored in data store 114, for example, to facilitate managing belonging-related information associated with users interacting with electronic devices 102-106. Server 110 may further be in communication with remote servers 120 either through the network 108 or through another network or communication means.

According to some aspects, remote servers 120 can be any system or device having a processor, a memory and communications capability for hosting various remote social networking sites. In one embodiment, remote servers 120 may be further capable of maintaining social graphs of users and their contacts. The remote social networking sites hosted on the remote server 120 may enable users to create a profile and associate themselves with other users at a remote social networking site. The remote servers 120 may further facilitate the generation and maintenance of a social graph including the user created associations. The social graphs may include, for example, a list of all users of the remote social networking site and their associations with other users of a remote social networking site.

In some example aspects, server 110 and/or one or more remote servers 120 can be a single computing device such as a computer server. In other embodiments, server 110 and/or one or more remote servers 120 can represent more than one computing device working together to perform the actions of a server computer (e.g., cloud computing). In some embodiments, server 110 and/or one or more remote servers 120 may be coupled with various remote databases or storage services. Communications between the client devices 102-106, server 110 and/or one or more remote servers 120 may be facilitated through the HTTP communication protocol. Other communication protocols may also be facilitated including for example, XMPP communication, for some or all communications between the client devices 102-106, server 110 and one or more remote servers 120.

Users 130-134 may interact with the system hosted by server 110, and/or one or more social networking sites hosted by remote servers 120, through a client application installed at the electronic devices 102-106. Alternatively, the user may interact with the system and the one or more remote social networking sites through a web based browser application at the electronic devices 102-106. Communication between electronic devices 102-106 and the system, and/or one or more remote social networking sites, may be facilitated through a network (e.g., network 108).

In one embodiment, users 130-134 may interact with the system maintaining a social graph of belongings, which is hosted at the server 110, to manage their belongings. Users 130-134 operating electronic devices 102-106 can manage their belongings, share their belonging-related activities with contacts and control, track and modify their posts (e.g., using server 110). For example, users 130-132 may access the system and may create a user profile including a user belonging profile displaying all belongings of the user within the social graph of belongings.

In one aspect, upon detecting a user request to interact with the system at a client device (e.g., electronic devices 102-106), the client device may initiate a communication with the system and send a data set including login information of the user. The data set can be transmitted from the user's client device (e.g., electronic devices 102-106) and received at server 110 hosting the system, for user authentication. Once the user is authenticated and access is granted to the user, the system may retrieve and send a data set to the user's client device, for displaying a graphical user interface at the client device operated by the user (e.g., electronic devices 102-106).

The system may further send a query to the user's client device (e.g., displayed within the graphical user interface displayed at the client device) for information regarding one or more social networking sites, the user is associated with. Upon receiving a response from the user's client device (e.g., in response to a selection by the user operating the device), the system may initiate establishing communication with one or more remote social networking sites (e.g., through network 108 and remote servers 120). For example, the system may cause the client device to reroute the user to the social networking site. The user's client device may then communicate with the social networking site and send login information to the social networking site, for example by sending a data set including the login information. The social networking site may authenticate the user using the received data set and may provide the user's client device with a token (e.g., a temporary token). The system hosted at server 110 may then retrieve the token from the user's client device, and may establish communication with one or more servers 120 hosting the remote social networking site using the token. For example, the communication may be facilitated using API calls. Similar steps may be performed for each of the one or more social networking sites associated with the user operating the client device.

Upon being granted access to each of the one or more social networking sites (e.g., through one or more remote servers 120), the system may then issue a request to each remote social networking site associated with the user to retrieve all contacts of the user. In one embodiment, for example, the system (e.g., through server 110) may issue an API call sent to the social networking site (e.g., sent from server 100 to one or more remote servers 120 through network 108). In one aspect, a remote social networking site hosted by one or more remote servers 120, may maintain a social graph comprising all contacts of each of its members, including the user. The social graph may be stored at the storage at the one or more remote servers 120 or may be stored remotely and the one or more remote servers 120 may access the remote storage and retrieve such information.

The social networking site may access the social graph and may retrieve the contacts of the user. The social networking site may further retrieve information associated with each contact or the association of the user with the contact, such as privacy preferences. The one or more remote servers 120 hosting the social networking site may provide the system (e.g., through server 110) with data sets including the contacts of the user, and may do so based upon contact information such as the privacy preferences. The server 110, upon receiving the contact information from one or more remote social networking sites, may store the data set including the contact information for each user (e.g., within the belonging profile of the belonging) at the server 110 (e.g., at storage 114). In one aspect, the contact information maintained at the server 110 may be updated periodically, by issuing a request to the one or more remote social networking sites (e.g., through one or more remote servers 120) and receiving updated data sets including user contact information.

The system may then provide the user's client device with an updated graphical user interface including the retrieved contacts of the user. Users 130-132 may interact with the graphical user interface provided by the system and displayed at the user's client device to add one or more belongings to their user profile. Each user may further enter belonging attributes regarding their belongings, such as a belonging name, a belonging image, a description and review regarding the belonging. Additionally, purchase information regarding a belonging may further be entered by a user of the system for each of the user's belongings. For example, information such as purchase receipts, warranty information and other such information may be inputted by the user and may be maintained at the system.

Still further, a user may assign a state for each of his/her belonging maintained within the social graph of belongings. A “belonging state” as used herein may refer to a status of the belonging. Belonging states may include, for example, the belonging being owned, borrowed, for sale, reviewed, given away, lent, or being a belonging the user wishes to purchase, borrow or own. Each user may additionally organize their belongings into different belonging categories, and may further select contacts with which activities regarding the newly added belonging may be shared. The entered information may then be sent from the user's client device, as a data set, to the system (e.g., through server 110) and may be stored at the server (e.g., at storage 114). The system (e.g., through server 110) may use the received information within the data set and may update the social graph of belongings maintained at the system (e.g., through server 110).

In addition to receiving belonging information, the system may further receive requests from the user's client device when the user wishes to share activities related to their belongings with contacts. Upon detecting a belonging-related activity performed by the user or upon a request from the user's client device to the system, the system may generate a post related to a belonging. Upon generating the post, the system may issue requests (e.g., API calls) to one or more remote social networking sites to display the post to selected contacts of the user at the one or more remote social networking sites. A data set including the post may be sent to the one or more social networking sites. The social networking site may then use the information included within the data set to display the post at the remote social networking site. Thus, the system may provide a platform where users can organize and share their belongings in a centralized and more effective way.

Posts generated with respect to belongings of users of the system may be stored within a database accessible by the system (e.g., at storage 114). A user of the system may interact with a graphical user interface displayed at the user's client device to request to access to posts regarding a belonging, and/or modify the posts regarding a belonging in response to an event (e.g., the belonging being sold, the belonging being lent, updated experience or views regarding the belonging, etc.). Upon receiving the request, the system may access the database storing the posts relating to belongings and may identify all posts associated with a specific belonging and/or all of the belongings of the user, and may generate a data set of the posts. The data set is then used to update the graphical user interface at the user's client device to display a list of the posts such that the user may view and modify one or more of the posts.

The system may further detect requests from the user's client device, for example, through a selection of the user at a graphical user interface presented at the client device to view a belonging-related stream including posts related to belongings of the social graph of belongings and/or by detecting a request from the user to view one or more posts related to a specific item. In one aspect, upon detecting the request, the system accesses a database, retrieves a data set of one or more posts and sends the data set to the user's client device. The graphical user interface of the user's client device may then be updated to display the belonging-related stream provided within the data set sent from the system.

Additionally, the system may detect a search request from the user's client device. A user of the client device may input search criteria and/or request a search of the belongings with regard to the search criteria. The system, upon detecting the request and/or the search criteria from the user's client device, may access one or more databases storing belongings, maintained in the social graph of belongings, as well as information regarding the belongings (e.g., belonging attributes of the belongings) and/or information regarding the user associated with the belonging (e.g., user attributes of the user). The system may then compare the belonging attributes of the belongings within the social graph of belongings, and/or the user attributes of the user associated with the belongings, against the search criteria and may retrieve one or more belongings from the social graph of belongings meeting the search criteria.

In one aspect, after identifying the belongings according to the search criteria, the system may further determine belongings associated with the user and/or belongings associated with contacts of the user within the social graph of belongings. In one aspect, the user may desire to search for all belongings include his/her own belongings, or alternatively, may wish to only search for belongings of other users of the system. This preference may be selectable by the user at the time of requesting the search (e.g., as a search query) or may be set as a general preference by the user. In one aspect, with respect to belongings of other users of the system, the system may further identify the belongings shared with the user (e.g., by a contact of the user). The system may filter the search results according to the sharing preferences of the users associated with the one or more belongings, such that only belongings associated with the user, or a contact of the user and/or shared with the user may be identified and provided to the user in response to the user's search request.

The system may then create a data set including the belongings meeting the search criteria. The data set may further include links to the belongings profile of each of the one or more belongings, and/or the profile of the user associated with the belongings. Upon receipt of the data sets, the graphical user interface displayed at the user's client device may be updated to display the information provided within the data set and may further allow the user to interact with the information. For example, a list of belongings meeting the search criteria may be displayed to the user including a link to a belonging profile and/or a link to the user associated with each belonging. The user may select the links, which will cause a graphical user interface displaying a belonging profile or a user profile to be provided at the user's client device. The user may then interact with the graphical user interface to view information regarding the belongings, including description, ranking and reviews of the belonging, or to view information regarding the user associated with the belonging (e.g., contact of the user) including the other belongings associated with the user within the social graph of belongings.

The system may provide users with the ability to easily share information about their belongings, know and control what is shared and with whom, preserve valuable information about their belongings, organize all the information shared regarding their belongings, including reviews and comments in one place, share their wishes to borrow or purchase an item with their contacts, seek recommendations from their contacts, sell, purchase, give away, borrow and lend their belongings, and search and browse belongings of other user of the system including their contacts.

While each of the users 130-134 may interact with the system through their respective client device 102-106, for exemplary purposes the interactions between the users and the system is hereinafter described with reference to user 130. In many instances, each user 130-134 may interact with the system in the same or similar manner described below with respect to user 130.

In one exemplary embodiment, user 130 interacting with electronic device 102 may register with the system hosted by server 110 and create a user profile. In one embodiment, upon registration, user 130 may access the system and add one or more belongings. User 130 may further share activities performed with respect to those belongings with his/her contacts on one or more remote social networking sites directly through the system hosted by server 110.

User 130 may interact with the system by logging into the system using pre-stored login information (e.g., a user name and password). If user 130 is a first time user, user 130 may register with the system and create login information (e.g., a user name and password) to be used for subsequent access to the system. Once in the system, user 130 may be presented with one or more graphical user interfaces allowing the user to interact with the system, add one or more belongings to the system, browse belongings of their contacts, share their belonging-related activities with contacts and receive recommendations and information regarding purchases.

In one aspect, user 130 interacts with the system maintaining the social graph of belongings when the user wishes to search for one or more belongings. In one aspect, user 130 may interact with the system, either directly through a graphical user interface of the system or through a third party application including a client application of the system or integrated with the system, and requests to search for one or more belongings. User 130 may wish to search for the one or more belongings according to one or more search criteria. The search criteria may be inputted by the user, either through a form provided to the user by the system (e.g., at a graphical user interface of the system or a third party application integrated with the system), or may be entered through a free form search entry box.

The criteria may include belonging attributes such as a belonging name, a belonging category, a user associated with the belonging, a belonging state, a geographic location of the belonging, whether the belonging has a description or review, and/or other similar belonging attributes attributable to a belonging. The search criteria may further include various user attributes of the user associated with a belonging

Belongings of the one or more users of the system may be stored within the social graph of belongings along with the name or other indication of the item corresponding to the belonging. For example, in one aspect, when users of the system attempt to add a belonging to the social graph of belongings, the system may, upon receiving a belonging entry from the user, determine an actual item corresponding to the entered name of the belonging and may associate the belonging with the specific item. To increase the accuracy of a search, the name of a belonging or item corresponding to a belonging used as search criteria may be automatically calculated by the system according to an input from the user.

User 130 may only enter a partial name of an item when requesting a search based on the name of an item corresponding to the belonging, and the system may detect and provide the user with suggestions regarding the specific item based on the input of the user. By auto-calculating a specific item name (e.g., the actual product name or service name including for example specific model or version numbers), the system is able to search for belongings within a social graph of belongings, where each user enters his or her belongings, and the belonging is uniquely associated with the user. In another aspect, the user may scan a barcode or click on a specific item and the system may detect the item as a search criteria. In other embodiments, other criteria may similarly be auto-calculated or completed. In such aspects, the name of the item may be used to provide a more accurate searching and indexing of the belongings within the social graph of belongings. In another embodiment, the system may account for the customized nature of the belongings stored within the social graph of belongings and may search for belongings that closely match the criteria, rather than an exact match of the criteria, and/or may generate alternative/additional search criteria in addition to the criteria provided by user 130 when performing the search.

Upon receiving a search request from user 130, the system may access the social graph of belongings, and determine belongings corresponding to the search criteria indicated by user 130. In one aspect, as described above, the social graph of belongings includes one or more users, each user associated with one or more belongings. Each belonging may further be associated with one or more contacts that the belonging and activities with respect to the belonging may be shared with. For example, when a belonging is added to the social graph of belongings, the user adding the belonging may indicate one or more contacts with which the belonging may be shared. Such sharing preferences may be stored within a database and associated with the belonging. Each belonging may be associated with a belonging profile having information and/or belonging attributes and may include the sharing preferences of the belonging.

Using the information maintained at the system, the system may identify one or more belongings corresponding to the search criteria specified by the user. The system may further determine whether user 130 is associated with the belonging or whether the user associated with the belonging (e.g., the user owning the belonging) is a contact of user 130. The system may further determine, whether the belongings meeting the search criteria have been shared with user 130. For example, the system may access sharing preferences of each of the identified belongings and may determine whether user 130 is one of the one of the one or more contacts indicated within the sharing preferences of the belongings. The system accordingly may identify those belongings corresponding to the search criteria, and may optionally filter the identified belongings based on whether the user associated with the belongings have authorized user 130 to view the belonging (e.g., by sharing the belonging with user 130).

The system may then provide a list of one or more belongings meeting the search criteria and in some aspects, being associated with the user 130 or a contact of user 130 and/or shared with user 130, to user 130. The list of belongings may be displayed as belonging icons including an image and name of the belonging. Each belonging listed may include a link to the belonging profile of the belonging. User 130 may select the link to view a belonging profile associated with the belonging. The selection of the link may result in the system accessing and displaying the belonging profile to user 130.

The list provided to the user in response to the search query may further include contacts owning belongings corresponding to the item. The system may determine the users associated with the belongings corresponding to the item, and may determine those users that are contacts of user 130 (e.g., those who have indicated user 130 as a contact or those which user 130 has indicated as a contact within one or more remote social networking sites). The list may, for example, include the name of the contacts and/or a link to each of the contacts (e.g., a belonging profile of the contact). User 130 may select the link to view a user profile of the contact including the belongings associated with the contact within the social graph of belongings. The selection may result in the system accessing and displaying the contact's user profile to user 130.

The system may further access a database of belonging-related posts and retrieve one or more posts associated with the belongings identified as a result of the search query. In one aspect, the system maintains posts generated in response to belonging-related activities of users associated with the social graph of belongings. Belonging-related activities may include activities such as adding a belonging, adding description regarding a belonging, ranking a belonging, writing a review for a belonging, purchasing a belonging, selling a belonging, adding a belonging to a wish list, seeking recommendations or feedback regarding the belonging and/or creating and sharing posts and/or comments regarding a belonging. Posts regarding each belonging may be associated with the specific belonging and stored within the database storing the belonging-related posts.

The system may access the database and retrieve all posts related to the belongings identified as a result of the search query. The system, upon accessing the posts, may determine which of the retrieved posts are associated with a user 130, a contact of user 130 and/or shared with user 130 (e.g., based on the sharing preferences indicated by the contact for the belonging and/or the post). The system may then provide a belonging-related stream of posts to user 130, where the posts are related to belongings meeting the search criteria and in one aspect associated with user 130 (e.g., generated by user 130, shared with user 130 and/or associated with a belonging shared with user 130). The belonging-related stream presented to user 130 may further be filtered such that only posts meeting the search criteria (e.g., having reviews) are displayed to the user.

Each belonging-related post may include a link associated with the user creating the post (e.g., contacts of user 130) and a link associated with the belonging the post is related to. The links may be embedded within the post, including the text and/or the image associated with the post. The links may be selectable by user 130 and upon selection may direct the user to a profile related to the link. For example, a link to each user provides access to the belonging profile of the user, while the link to a belonging provides access to the belonging profile of the belonging.

For example, each post may include the name of the user associated with the post. The link to the user may be embedded within the name. User 130 may select the link to view a profile of the user associated with the post, which may be a contact of user 130. The selection may result in the system accessing and displaying the profile (e.g., a contact belonging profile) of the user associated with the post.

Each post may further include a link to the belonging the post is associated with. The link may be embedded within the post, including for example within the image included with the post and/or within the text of the post. For example, where the text of the post includes the name of the belonging, a link may be embedded within the belonging name. User 130 may select the link to view a belonging profile associated with the belonging. The selection of the link may result in the system accessing and displaying a belonging profile associated with the belonging to user 130.

Upon being provided with the list of results, user 130 may, viewing the list of belongings, and the contacts and/or posts associated with belongings, and ask for feedback, reviews and recommendations regarding the belongings from the contact associated with each belonging and/or post. The user may additionally ask to borrow a belonging from a contact associated with the belonging.

The system may, upon detecting the user request to receive feedback from his/her one or more contacts, begin the process of generating a feedback request and distributing the feedback request to the selected contacts of the user. For example, the request for feedback may be sent to the social networking site to be displayed to the one or more contacts at the social networking site or displayed to the selected contacts when the contacts are interacting with a graphical user interface of the system.

For example, user 130 may seek recommendations and feedback regarding one or more belongings by placing posts or comments on the belonging profile or contact profile of contacts owning a belonging corresponding to the item. The user may further create a post asking for feedback regarding an item of interest and may share the post with one or more selected contacts. For example, the selected contacts may include those contacts indicated as owning belongings corresponding to the item.

In one aspect, the post may be directed to a specific contact or list of contacts, or may be generally directed to all contacts owning a belonging meeting the search criteria indicated by user 130. In yet a further embodiment, the post may be viewable by one or more contacts having other similar belongings or generally having product-related knowledge of value to user 130. In some embodiments, the other contacts as well as the contact(s) owning belongings corresponding to the item may be able to provide comments and feedback to user 130.

In one aspect, the generated post may be customized with respect to each of the one or more belongings meeting the search criteria and may specifically refer to a unique belonging of a specific contact, such that the post is associated with the belonging. Alternatively, a general post referring to an item, and not uniquely associated with any one unique belonging instance may be generated and sent to all contacts having a belonging corresponding to an item.

Additionally, user 130 may request to try out the item from contacts owning a belonging corresponding to the search criteria. For example, the user may view the contacts owning the belongings identified in response to the search request, and may generate a request, post or comment, displayed to one or more contacts, to borrow one or more of the belongings. The system may allow user 130 to keep track of items he has borrowed as well as items he has lent to other users. For example, user 130 may request to borrow a belonging of a contact. Once the belonging is lent to user 130, the contact, may modify the state of the belonging (e.g., by interacting with a graphical user interface of the system displaying a belonging profile) to indicate that the item has been lent to user 130. The system may then modify the state of the belonging maintained within the social graph of belongings. The system may further create a new association between user 130 and the belonging lent to user 130, within the social graph of belongings. The belonging may then be indicated as being borrowed in the user's belongings. Thus, both user 130 and his/her contact may keep track of items that have been lent to user 130. User 130 may tryout the item to help in making a decision to purchase the item.

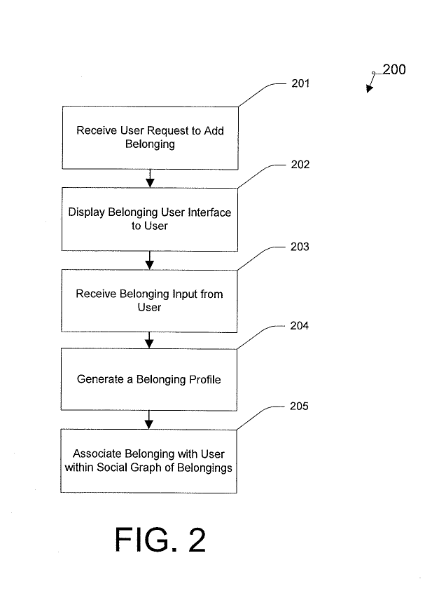

FIG. 2 illustrates a flow chart illustrating a process 200 for generating and maintaining a social graph of belongings. The process 200 begins in step 201 when the system receives a user request to add a new belonging, for example from user 130. In some aspects, the request may be received when user 130 selects to add a belonging, for example by selecting the add button when viewing a graphical user interface of a belonging profile or when viewing a graphical user interface of a user profile. Alternatively, the system may receive the user request to add a new belonging when user 130 selects a suggested belonging provided to the user by the system.

Next, in step 202 the system displays a graphical user interface to user 130 for adding a new belonging. User 130 may then enter belonging attributes regarding the belonging, such as a name of the belonging, an image of the belonging, contacts to share activities related to belongings with, belonging categories associated with the belonging, a belonging sharing preference, belonging description, belonging review and ranking, belonging state and/or belonging purchase information.

In step 203, the system receives a belonging input from the user. For example, the user may select a save item button, and the information regarding the belonging may then be received by the system. Next, the process continues to step 204 in which the system generates a belonging profile based upon the information entered by user 130 and received in step 203. Next, in step 205, the system associates the belonging and/or the belonging profile with user 130. As described above, a social graph of belongings may be generated and maintained by the system. The social graph of the belongings, according to some aspects, includes associations between a user and belongings of that user for all users of the system. In step 205, the system may add the new belonging entry into the social graph of belongings as a belonging of the user 130, thus expanding the social graph of belongings through the new user-belonging association. In this manner, the belongings are stored in an indexable manner within the social graph of belongings and may be retrievable, for example, according to the attributes of the belonging (e.g., attributes entered by user 130 and stored within a belonging profile).

User 130 may add a belonging to his/her profile and may indicate the belonging as an item user 130 wishes to purchase, own or borrow (hereinafter referred to as a “wish list belonging”). As used herein, a “wish list belonging” may refer to a belonging which a user may wish to own, purchase, borrow, and/or learn more about. For example, such belongings may be included within the social graph of belongings associated with user 130. The wish list belongings may be assigned to a belonging category dedicated to belongings user 130 may not own but may wish to own, purchase or borrow, and/or belongings user 130 may be generally interested in purchasing. For example, in one aspect, user 130 may add a belonging and may add the belonging to a category indicated for wish list belongings of user 130. In another example, user 130 may assign a state to each belonging when the belonging is being added. The state of a belonging may be indicated as wish to purchase, wish to borrow, wish to own or wish to learn more about. In one aspect, contacts of user 130 may view the belongings indicated as a wish list belonging that the user is interested in purchasing, owning or learning more about and may provide comments and feedback regarding the belonging.

Furthermore, contacts may be able to view the wish list belonging, once within the system, and may be able to comment on the wish list belonging or may recommend the wish list belonging. Wish list belongings may be displayable within the profile displayed to user 130 (e.g., a wish list area or tab within a user profile of user 130) or a contact of user 130 interacting with the system (e.g., within a contact profile associated with user 130).

Once the item has been added as a belonging of user 130 and indicated as being a wish list belonging of user 130 (e.g., belonging having a belonging state indicating that the user wishes to purchase, own or borrow the item, or belonging being categorized as a wish list belonging), the user may then create, and/or the system may generate, one or more posts, shared with one or more contacts of user 130, to ask for feedback or comments regarding the belonging. When a belonging is added by user 130 and indicated as a wish list belonging, the system may generate a post to one or more selected contacts asking for recommendations regarding the belonging and/or announcing that user 130 has added a new belonging to his wish list. The post may be distributed to the selected contacts and displayed at one or more remote social networking sites. The post may further be stored within a database of posts and displayable within a belonging-related stream. In one aspect, the selected contacts to whom the post is distributed may include those contacts identified by the system as owning a belonging corresponding to the item the wish list belonging corresponds to.

The post may be distributed to one or more remote social networking sites and displayed at the remote social networking sites to the one or more selected contacts. The selected contacts may then enter feedback or reviews regarding the belonging at the social networking site. The comments and feedbacks are associated with the post and may be retrieved and stored in the database of posts and comments along with the post. For example, each post may include a unique identification, and posts and comments created by users in connection with the post may be associated with the unique identification such that the comments and posts associated with the post may be retrieved from the remote social networking site and displayed to the user locally when interacting with the graphical user interface of the system (e.g., within a belonging-related stream).

Furthermore, contacts of the user may comment on the belonging and provide feedback regarding the belonging by interacting with the system (e.g., through a graphical user interface of the system). For example, when contacts of user 130 view the profile of user 130 and/or belonging profile associated with the wish list belonging, the contacts may view the posts associated with the request for feedback and may provide feedback and reviews regarding the belonging. In one aspect, the contacts of user 130 include users associated with a belonging corresponding to the item corresponding to the wish list belonging.

In addition, once the belonging has been added and indicated as a wish list belonging, the system may generate a belonging-related stream of posts associated with the wish list belonging. In one aspect, the posts included within the belonging-related stream may include posts regarding the belonging (e.g., posts by user 130 and/or contacts of user 130 directed at the wish list belonging) and associated with user 130 (e.g., shared with user 130 or generated in response to a belonging-related activity of user 130). In another embodiment, the stream may comprise posts relating to one or more other belongings of other users of the system (e.g., user 132 and 134), the belongings corresponding to item the wish list belonging corresponds to and associated with user 130.

The system may determine the item corresponding to the wish list belonging and identify one or more other belongings within the social graph of belongings corresponding to the same item. The posts relating to the identified belongings may then be identified and displayed in addition to or in lieu of the posts associated with the wish list belonging maintained within a belonging-related stream.

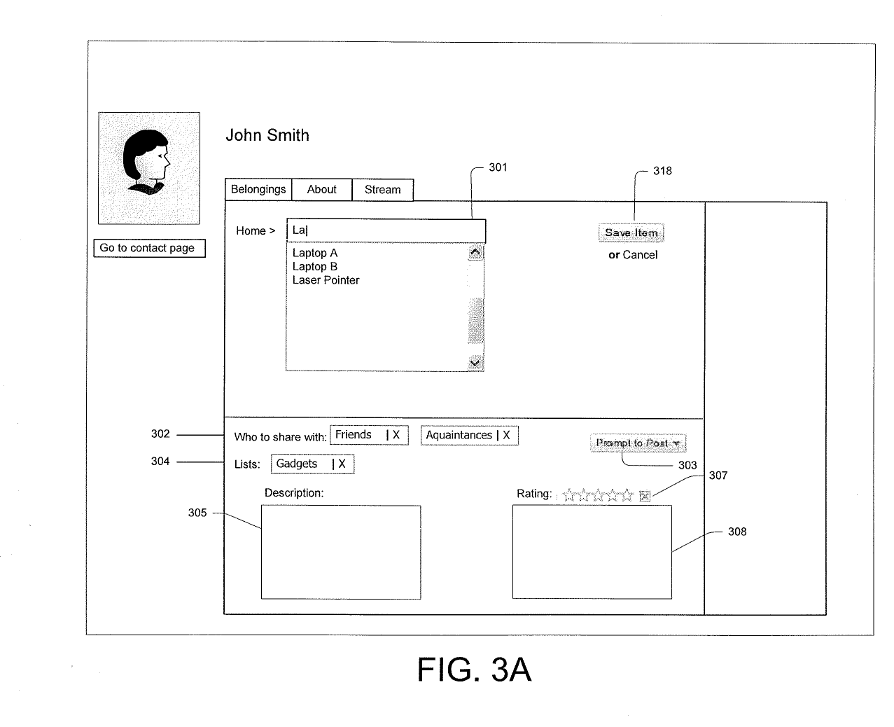

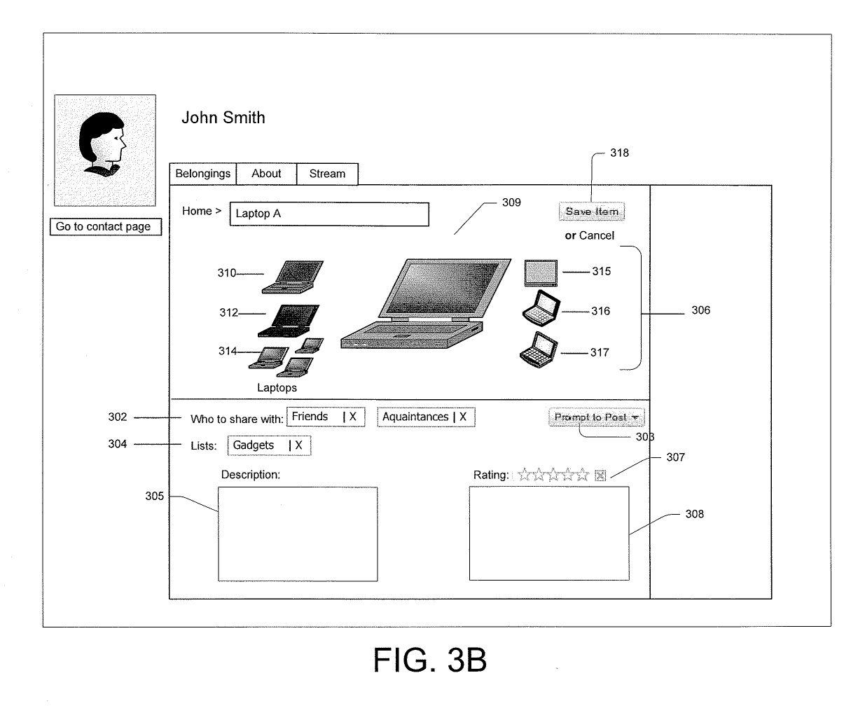

FIGS. 3A and 3B illustrate screen-shots of an example graphical user interface for adding a new belonging to the belongings of a user. The graphical user interface of FIG. 3A illustrates an item entry section 301. The item entry section 301 is illustrated as a text entry box, which may have an auto fill option such that user 130 enters a section of an item name within the text entry box and the system provides one or more possible items. User 130 may either complete the name or may select one of the auto fill options provided in the drop down list. The system may receive the user's input within the text entry box of item entry section 301, may auto-compute possible items and may present the items as options to the user.

In one aspect, when adding a belonging (e.g., a wish list belonging), the user may enter a name of an item corresponding to belongings or other indication of a belonging name or identification. The system may then determine a full name or identifier of the item associated with the belonging and may associate the belonging with the item corresponding to the belonging. Thus, each belonging maintained within the social graph of belongings corresponds to an item, and therefore while each belonging is unique and customized to the user associated with the belonging, one or more belongings may correspond to the same or similar item. The system may determine the item corresponding to the wish list belonging and identify one or more other belongings within the social graph of belongings corresponding to the same item. In this manner, the belongings of the user may be more accurately stored using actual product names. The user may alternatively be presented with specific queries regarding the entered product such as serial number information, product version, product name, product developer and other product specific information, to determine the actual item associated with the belonging being inputted by user 130.

Once user 130 enters the name of the belonging, or selects the intended belonging from the auto fill options provided, at the item entry section, one or more available images of the selected item may be displayed to the user within the image selection section 306 as illustrated in the graphical user interface of FIG. 3B. The images displayed with the image selection section 306 may include images uploaded by user 130, and/or images retrieved by the system based on the information entered within the item entry section 301. One or more images of an item may be displayed to the user as illustrated in the graphical user interface of FIG. 3B. In one instance, as illustrated in the graphical user interface of FIG. 3B, a first image 309 may be displayed as a main image, with alternative images 310-317 additionally displayed. Alternatively, fewer or no alternative images may be displayed to the user. User 130 may select to change the main image by selecting the change picture option illustrated in the graphical user interface of FIG. 3B. In one example, the alternative images 310-317 may be displayed once user 130 chooses to change the image. The user may thus select the desirable image to be associated with the belonging.

The graphical user interface of FIGS. 3A and 3B further illustrate a contact selection section 302. In one embodiment, the contact selection section 302 may display all contacts or groups of contacts (e.g., social circles), associated with the user 130. Alternatively, the contact selection section 302 may display the most recent contacts user 130 has shared his/her post with and may display those contacts or contact groups to user 130. In one aspect, the belonging may be a wish list belonging, and the contacts displayed to the user may include those contacts being associated with belongings corresponding to the item entered by user 130. User 130 may remove one or more contacts or contact groups or may add one or more additional contacts or contact groups within the content selection section 302. The content selection section 302 may display other ways for selecting contacts, such as a drop down menu of all contacts and contact groups or a search tab for searching for contacts or contact groups by name.

In one embodiment, the contacts and contact groups displayed in contact selection section 302 represent contacts of the user stored within the social graph of one or more remote social networking sites. In one instance, contacts and contact groups of user 130 are presented once user 130 provides the system with access to the one or more remote social networking sites the user is a member of. For example, in one aspect, the contact selection section 302 of the graphical user interface of FIG. 3A may include icons for one or more remote social networking sites. The remote social networking sites, in one aspect, include remote social networking sites hosted by remote servers 120 and in communication with the system (e.g., through network 108). The system, in one instance, includes the capability to facilitate communication with the one or more remote networking sites, and is able to access the social graphs maintained at the remote social networking sites and retrieve contacts of a user stored within the social graph maintained at each remote social networking site.

According to several embodiments of the present system, user 130 may select the icons for each remote social networking site at which user 130 has contacts. In some aspects, the selection of the icon for each remote social networking site will reroute user 130 to the remote social networking site where the user may log into the social networking site using his/her login information pertaining to the selected remote social networking site. The user may then be routed back to the system with a token, enabling the system to access the user's information and contacts at the selected remote social networking site and retrieve the user's contacts.

The graphical user interface of FIGS. 3A and 3B further illustrate a sharing preference selection menu 303. The sharing preference selection menu allows user 130 to have control over how his/her belonging-related posts and activities are shared with contacts. The graphical user interface of FIGS. 3A and 3B illustrate the sharing preference selection menu 303 being set at the “prompt to post” option. In some instances, when user 130 has selected the prompt to post option, the system may generate a post when a new activity with regard to the belonging being added is selected. The system then prompts user 130 that the post has been generated and the user will choose whether to share the post, or to forgo sharing the activity with contacts. User 130 may, in some instances, modify the text of the generated post before selecting to share the post with his/her contacts.

In addition to the prompt to post option illustrated in the graphical user interface of FIGS. 3A and 3B, the sharing preference selection menu 303 may provide additional options including, for example, never sharing posts related to the belonging being added in the graphical user interface of FIGS. 3A and 3B, and always sharing posts related to the belonging being added in the graphical user interface of FIGS. 3A and 3B, without first prompting the user. The additional sharing preference options may be selectable by the user through a drop down arrow illustrated on the sharing preference selection menu 303 of the graphical user interface of FIGS. 3A and 3B.

The graphical user interface of FIGS. 3A and 3B further illustrate a belonging categorization section 304. The belonging categorization section 304 allows user 130 to categorize the belonging being added. User 130 may organize his or her belongings into different categories such as for example gadgets, books, sports gear, wardrobe and electronics. The system may further categorize his/her belongings, for example, based on whether the belonging is owned by user 130 or is a wish list belonging of user 130. According to several aspects, there may virtually be no limitation on the number or name of the belonging categories created by user 130. In one embodiment, the belonging categorization section may display all categories created by user 130. Alternatively, the belonging categorization section 304 may display the most recent category used by user 130. User 130 may remove one or more categories or may add one or more additional categories within the belonging categorization section 304. The belonging categorization section 304 may display other ways for selecting categories, such as a drop down menu of all categories created by the user or a search tab for searching for categories by name. In some instances, user 130 may be able to place the same belonging maintained within multiple categories.

A description entry box 305 is further illustrated in the graphical user interface of FIG. 3A, allowing user 130 to enter a description regarding the belonging being added. Similarly, a rating entry box 308 and rating indicator 307 are illustrated in the graphical user interface of FIG. 3A. A user may rate the belonging being added using the rating indicator 307, for example by clicking on a specific star, indicating the rating of the belonging. User 130 may further enter comments or reviews regarding the belonging in the rating entry box 308. In one or more aspects, the description entry box 305 and rating entry box 308 may accept any text and/or graphical entry.

In one aspect, additional data fields may further be provided to user 130 and the user may enter further information regarding a belonging. For example, purchase information regarding a belonging may be entered by user 130 for one or more of his/her belongings. Such purchase information may include information such as purchase receipts, warranty information and other such information. Such information may be received and maintained at the system for future use. As another example, a user may assign a state of each of his/her belonging maintained within the social graph of belongings. A “belonging state” as used herein may refer to a status of the belonging. Belonging states may include, for example, the belonging being owned, borrowed, for sale, reviewed, given away, lent, or being a belonging the user wishes to buy, borrow, own. In another embodiment, the belonging state may be automatically assigned by the system (e.g., upon detecting that the item has been purchased).

The graphical user interface of FIGS. 3A and 3B further illustrate a “save item” button 318. Once user 130 has completed all information regarding the belonging, user 130 may select the save item button 318. The selection of the save item button 318 prompts the system to add the belonging to the social graph of belongings. Upon detecting that user 130 has added a belonging, the system may initiate the process of adding the belonging to the social graph of belongings maintained by the system as described above with respect to FIG. 2.

The system may further detect the sharing preference of user 130, for example as indicated by the option user 130 selected from the sharing preference selection menu 303. Based upon the preference indicated by user 130, the system may generate a post to be shared with the selected contacts of user 130. For example, if the user selected the prompt to post option or the always post option, the system will generate a post indicating user 130 has added a new belonging.

In some aspects, once user 130 and the belonging inputted by user 130 have been associated with the user within the social graph of belongings, the system may then generate and distribute posts related to the belonging to one or more contacts of user 130. In one embodiment, user 130 selects one or more contacts and/or groups of contacts, which the user wishes to share the user's belonging activities with. In some embodiments, adding the belonging is detected as a belonging-related activity and thus the system may initiate the process for generating and sharing a post related to the belonging with the contacts selected by the user.

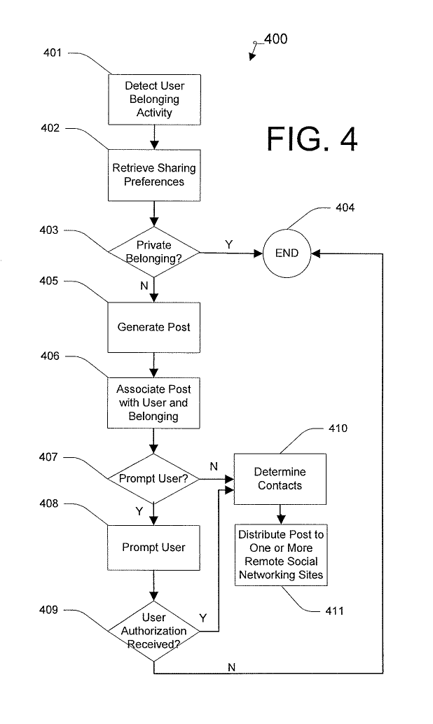

FIG. 4 illustrates a flow chart illustrating a process 400 for generating and distributing a belonging-related post representing a user activity with respect to a belonging. In step 401, the process 400 begins when the system detects a belonging-related activity by a user, for example user 130. As described above, the belonging-related activity may include a new belonging being added. Other examples of belonging-related activity may include a user modifying a belonging, deleting a belonging, adding a new post regarding a belonging and adding a new comment regarding the belonging.

Upon detecting the belonging-related activity, in step 402 the system retrieves sharing preferences with respect to the belonging. The sharing preference of a belonging may be stored within the belonging profile of the belonging generated in step 204 of process 200. A user (e.g., user 130), may set the sharing preferences by selecting a sharing preference when adding the belonging. User 130 may also modify the sharing preferences for a belonging already added and stored within the social graph of belongings, for example by selecting to modify the belonging, or by setting the sharing preference upon receiving a prompt when a post is being shared with contacts of the user.

In step 403, based on the retrieved sharing preferences, the system may determine whether the activity detected in step 401 is associated with a private belonging. When a user selects to not share any posts regarding a belonging with contacts, the belonging may be stored as a private belonging. Similarly, the post may also be private if no contacts are selected.

If in step 403, the system determines that the belonging is a private belonging, then the process ends in step 404. Otherwise, in step 405, the system generates a post regarding the belonging-related activity detected in step 401. Generating a post may comprise generating text regarding the activity and appending an image of the belonging to the text to generate a post. The text may be system generated and pre-stored text. For example, the system may store pre-generated text associated with each specific action, and upon detecting the action, may retrieve the pre-stored and pre-generated text associated with the specific action detected in step 401. In another embodiment, the text may include user-generated text, for example, text entered within a post entry box. The image may, in some examples, correspond to the main image selected by user 130 and stored within the belonging profile of the belonging associated with the detected belonging-related activity.

Next, in step 406, the system associates the post with the belonging associated with the belonging-related activity detected in step 401, and further with user 130 associated with the belonging. In one instance, each post may be assigned a unique identifier. The unique identifier may be associated with a belonging the post is related to and/or a user associated with the belonging. In one exemplary instance, the system may track the post through the unique identifier. For example, the post may be linked with the unique identifier such that after distribution the post may be retrieved and modified using the link, even after the post has be distributed and displayed to contacts.

In step 406, a link associated with user 130 and a link associated with the belonging may further be included within the post generated in step 405. In one instance, for example, the generated post may include the name of user 130 and the name of user 130 may include a link to user 130. In one embodiment, the link to user 130 may be selectable and upon selection may access and display the belonging profile of user 130. In another instance, a link to the belonging may be included within the post. For example, in one instance the link may be inserted within the text or image of the post. The link to the post may be selectable and upon selection may access and display the belonging profile of the belonging.

In step 407, the system may determine whether user 130 should be prompted before the post is shared. For example, the system may look at the sharing preference retrieved in step 402 to determine whether user 130 has selected the prompt to post option. If it is determined that user 130 should be prompted, the process 400 continues to step 408 and prompts user 130, for example by displaying a prompt window. The user may in some instances view and modify the post, before authorizing that the post be shared with contacts. Next, in step 409, the system determines whether user 130 has authorized sharing the post with contacts selected by user 130. If it is determined that user 130 has not authorized the post, then the system continues to step 404 and ends the process.

Otherwise, in step 410 the system determines contacts to share the post with. The contacts may be stored within the belonging profile. In one embodiment, the determined contacts may be associated with one or more remote social networking sites. In step 411, the system distributes the post to the one or more remote social networking sites, and requests that the post be displayed to the selected users identified in step 410. Similarly, if in step 407 it is determined that that user 130 should not be prompted, the process 400 continues to step 410 and then to step 411 where the post is distributed to the one or more remote social networking sites, requesting that the post be displayed to the determined contacts at the one or more remote social networking sites.

The one or more remote social networking sites may provide API functionality for receiving and posting posts. In such embodiments, the system generates an API call to each of the one or more remote social networking sites to display the post. In one instance, the post may be displayed along with other posts by user 130 within the one or more remote social networking sites and shared with the one or more determined contacts. The post may further be stored within a database maintained by the system. A date and time associated with the posts (e.g., the time the post was created, generated or stored) may be stored with the post for later retrieval and display within a belonging-related stream. Upon being displayed at the remote social networking site, the selected contacts may then enter feedback or reviews regarding the post at the social networking site. The comments and feedbacks are associated with the post and may be retrieved and stored in the database of posts and comments along with the post. For example, each post may include a unique identification, and posts and comments created by users in connection with the post may be associated with the unique identification such that the comments and posts associated with the post may be retrieved from the remote social networking site and displayed to the user locally when interacting with the graphical user interface of the system.

After distribution, the post may be retrieved and modified using the unique identifier, the link to the user and/or the link to the belonging. For example, a user may modify information regarding the belonging, may delete the belonging or may perform other activity with respect to the belonging. In such instances, it may be beneficial to update the posts related to the belonging in view of the action performed by the user.

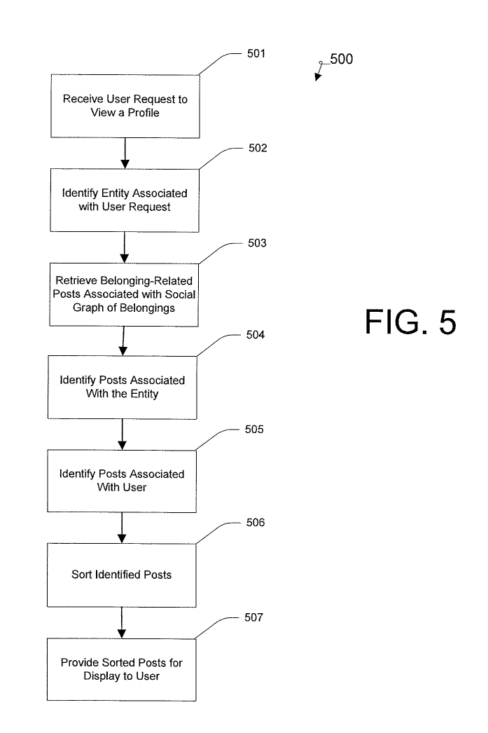

FIG. 5 illustrates a flow chart illustrating a process 500 for displaying a belonging-related stream to a user of the system maintaining a social graph of belongings. At step 501, the process begins when the system receives a user request to view a profile from a first user of the system (e.g., user 130). The user request may be detected in response to various selections and input from user 130.

The user request received in step 501 may be a user request to view a user profile (e.g., a profile of the user including the belongings of the user within the social graph of belongings), a belonging profile (e.g., a profile of a belonging including different attributes of the belongings) or a contact profile (e.g., a user profile of a contact including the belongings of the contact within the social graph of belongings). The user request may be received when user 130 first enters the system, for example by logging into the system. User 130 may enter the system by logging into the system using pre-stored login information (e.g., a user name and password). If user 130 is a first time user, user 130 may register with the system and create login information (e.g., a user name and password) to be used for subsequent access to the system. In one aspect, the system detects the user request when user 130 logs into the system.

Additionally, the user request may be received when user 130 requests to view a profile by selecting a link (e.g., a link to a user or a link to a belonging). For example, the system may receive a user request in response to the user 130 selecting a link to the user or a belonging embedded within a post or comment. In another embodiment, belongings displayed within a user profile or a contact profile may include a selectable link and user 130 may select the link, which may be detected by the system as a user request to view a profile relating to the selected user and/or the selected belonging.

Furthermore, the user may request to view a profile, by selecting a belonging tab. The request may also comprise an entry of a user within a search tab or other text entry field, which allows the user to access a profile. The request may further be received when the user indicates an interest in purchasing an item and/or adds a wish list belonging. The request may similarly be received when the user requests a search of belongings. In other aspects, a request may be received through other user input or user selection.

In step 502, the system identifies the entity associated with the request. As described above, a request may be associated with a user of a system (e.g., user 130 or a contact of user 130), a belonging of a user of the system, or an item a user may wish to borrow or purchase. In one aspect, the users and belongings are those associated with the social graph of belongings. In step 502, the system analyzes the user request to determine the entity associated with the user request received from the user (e.g., one or more belongings or contacts corresponding to the request).

Next, in step 503 the system accesses the posts stored within the system (e.g., posts associated with the social graph of belongings). In step 504, the system identifies one or more posts of the retrieved posts associated with the identified entity (e.g., with the user, belonging or item).

For example, if the request is associated with the user 130, the posts identified in step 504 may include posts created by user 130, posts generated in response to belonging-related activity of user 130, posts by other users of the system regarding one or more belongings of user 130 and/or posts by other users of the system shared with user 130. Alternatively, if the profile is identified as being associated with a contact of user 130 (e.g., user 132), the posts identified in step 504 may include posts created by user 132, and/or posts generated in response to belonging-related activities of user 132. On the other hand, if the profile is identified as being associated with a belonging, the posts identified in step 504 may include posts created by users of the system (e.g., users 130, 132 and 134) regarding the belonging or posts generated in response to belonging-related activity with respect to the belonging.

If the request is associated with an item the user wishes to purchase, then the posts identified in step 504 may include those posts associated with on or more belongings identified as corresponding to the item, posts associated with contacts of user 130 associated with a belonging corresponding to the item, or to comments, feedback and posts corresponding to the item (e.g., when the user 130 requests feedback from his/her contacts regarding the item). If the request is associated with a search request by user 130, then the posts identified in step 504 may include those posts associated with on or more belongings identified in response to the search request. The posts may include those posts associated with user 130, contacts of user 130, or to comments, feedback and posts corresponding to one of the identified belongings.

In step 505, the system may determine which of the posts identified in step 504 are associated with the user (e.g., user 130). The posts associated with user 130 may include posts created by user 130, posts generated in response to belonging-related activities performed by user 130, posts regarding the belongings of user 130 and/or posts shared with user 130 by other users of the system.

Next, in step 506, the posts identified in step 505 may be sorted. The posts may be sorted according to date and time of the post, or may be sorted according to other criteria specified by user 130. In one aspect, the posts identified in step 505 may further include comments corresponding to the post. For example, each post may include a unique identification, and posts and comments created by users in connection with the post may be associated with the unique identification. In one example, comments having been shared with user 130 or entered by user 130 may further be retrieved. The posts may further be sorted according to the date and time of the comments associated with each of the one or more posts.

Finally, in step 507, the system provides the belonging-related stream for display to the user. For example, the system may present user 130 with a user graphical interface displaying a belonging-related stream including the one or more of the posts and comments identified in step 505 as sorted in step 506. The number of posts displayed within the graphical user interface may depend upon the number of posts identified in step 505, a predefined number based on system settings or user preference, and/or the number of posts that may be displayed within the graphical user interface.

Each belonging-related post may include a link associated with the user creating the post and a link associated with the belonging the post is related to. The links may be integrated within the post, including the text and/or the image associated with the post. The links may be selectable by user 130 and upon selection may direct the user to a profile related to the link. For example, a link to each user provides access to the belonging profile of the user, while the link to a belonging provides access to the belonging profile of the belonging.

For example, each post and/or comment may include the name of the user associated with the post. The link to the user may be embedded within the displayed name. User 130 may select the link to view a belonging profile associated with the author of the post, which may be a contact of user 130. The selection may result in the system accessing and displaying the belonging profile of the user associated with the displayed post

Each post and/or comment may further include a link to the belonging the post is associated with. The link may be embedded within the post, including for example within the image included with the post and/or within the text of the post. For example, where the text of the post includes the name of the belonging, a link may be embedded within the belonging name. Additionally or alternatively, the link may be embedded within the image displayed along with each post. User 130 may select the link to view a belonging profile associated with the belonging, which may be a belonging of user 130 or a belonging of another user of the system, for example a contact of user 130. The selection of the link may result in the system accessing and displaying the belonging profile to user 130.

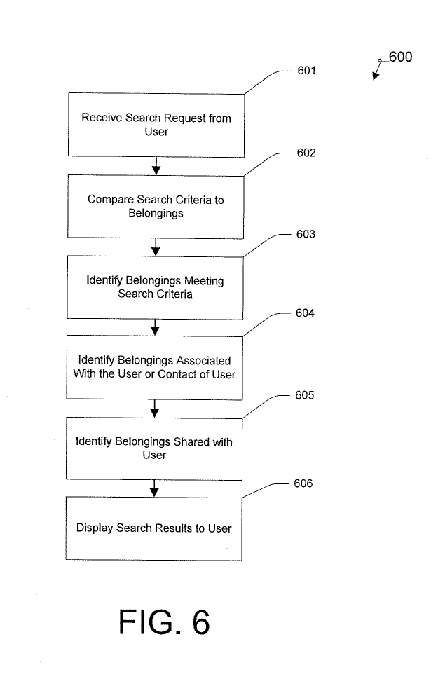

FIG. 6 illustrates a flow chart illustrating a process 600 for providing a user with one or more belongings in response to a search request by referencing a social graph of belongings. In step 601, the system receives a search request from a user of the system (e.g., user 130) to search for belongings. The request may include one or more search criteria. In one aspect, user 130 interacts with the system maintaining the social graph of belongings when the user wishes to search for one or more belongings.

In one aspect, user 130 may interact with the system, either directly through a graphical user interface of the system or through a third party application including a client application of the system or integrated with the system, and request to search for belongings. User 130 may wish to search for belongings according to one or more search criteria. The search criteria may be inputted by the user, either through a form provided to the user by the system, or may be entered through a free form search entry box (e.g., at a graphical user interface of the system or a third party application integrated with the system).

The criteria may include belonging attributes such as a belonging name, a belonging category, a user associated with the belonging, a belonging state, a geographic location of the belonging and/or the user associated with the belonging, whether the belonging has a description or review, and/or other similar attributes attributable to a belonging. The search criteria may further include various attributes of the user associated with a belonging.

In step 602, upon receiving the request and/or the search criteria from user 130, the system may access one or more databases storing belongings, maintained in the social graph of belongings, as well as information regarding the belongings (e.g., attributes of the belonging) and/or information regarding the user associated with the belonging (e.g., attributes of the user). The system may then compare attributes of the belongings within the social graph of belongings, and/or the attributes of the user associated with the belongings, against the search criteria.

Belongings of the one or more users of the system may be stored within the social graph of belongings along with an indication of the item corresponding to the belonging. For example, in one aspect, when users of the system attempt to add a belonging to the social graph of belongings, the system may, upon receiving a belonging entry from the user, determine an actual item corresponding to the entered name of the belonging and may associate the belonging with the specific item.

To increase the accuracy of a search, the name of an item/belonging used as search criteria may be automatically calculated by the system according to an input from the user. User 130 may only enter a partial name of the item and the system may detect and provide the user with suggestions regarding the specific item based on the input of the user. By auto-calculating a specific item name (e.g., the actual product name or service name including for example specific model or version numbers), the system is able to search for belongings within a social graph of belongings, where each user enters his or her belongings, and the belonging is uniquely associated with the user. In another aspect, the user may scan a barcode or click on a specific item and the system may detect the item as an item of interest to the user.

Other criteria may similarly be auto-calculated or completed. In such aspects, the name of the item may be used to provide a more accurate searching and indexing of the belongings within the social graph of belongings. The system may account for the customized nature of the belongings stored within the social graph of belongings and may search for belongings that closely match the criteria, rather than an exact match of the criteria, and/or may generate alternative/additional search criteria in addition to the criteria provided by user 130.

Upon receiving a search request from user 130, the system may access the social graph of belongings, and determine belongings corresponding to the search criteria indicated by user 130. In one aspect, as described above, the social graph of belongings includes one or more users, each user associated with one or more belongings. Each belonging may further be associated with one or more contacts that the belonging and activities with respect to the belonging may be shared with. For example, when a belonging is added to the social graph of belongings, the user adding the belonging may indicate one or more contacts with which the belonging may be shared. Such sharing preferences may be stored within a database and associated with the belonging. Each belonging may be associated with a belonging profile having belonging information and/or attributes and may include the sharing preferences of the belonging.

In step 603, the system may access one or more belongings from the social graph of belongings meeting the criteria. Using the information maintained at the system, the system may identify one or more belongings meeting the search criteria specified by the user. In one aspect, the system may determine a matching score of other matching indication for each belonging based on comparing the attributes of the belonging, and/or the user associated with the belonging, with the search criteria. The system may then compare the matching indication relative to a predetermined threshold or relative the matching indication of other belongings to identify the one or more belongings meeting the search criteria.

In one aspect, after identifying the belongings according to the search criteria, the system may, in step 604, further determine which of the belongings identified in step 603 are associated with user 130 and/or associated with a contact of user 130 within the social graph of belongings. As described above contacts of user 130 include friends, social circles, groups and other users that the user is associated with, at one or more remote social networking sites. In one aspect, the contacts of user 130 may be identified and maintained locally at the system while in another embodiment, the system may query one or more remote social networking sites when determining whether a user associated with a belonging is a contact of user 130. In one aspect, the user may desire to search for all belongings including his/her own belongings, or alternatively, may wish to only search for belongings of other users of the system. This preference may be selectable by the user at the time of requesting the search (e.g., as a search query) or may be set as a general preference by the user.

With respect to belongings of other users of the system, in step 605, the system may further identify the belongings shared with the user (e.g., by a contact of the user). The system may filter the search results according to the sharing preferences of the users associated with the one or more belongings, such that only belongings associated with the user, or a contact of the user and/or shared with the user may be identified and provided to the user in response to the user's search request.

Next, in step 606 they system may provide a list including a representation of the one or more belongings identified in response to the search request (e.g., identified during one or more of steps 603, 604 and/or 605). The list of belongings may be displayed as belonging icons including an image and name of the belonging. Each belonging listed may include a link to the belonging profile of the belonging. User 130 may select the link to view a belonging profile associated with the belonging. The selection of the link may result in the system accessing and displaying the belonging profile to user 130. In one aspect, the belongings retrieved may be further filtered (e.g., upon request by the user) to display only belongings having a review, ranking and/or description.

The list provided to the user in response to the search query may further include contacts owning belongings corresponding to the item. The system may determine the users associated with the belongings corresponding to the item, and may determine those users that are contacts of user 130 (e.g., those who have indicated user 130 as a contact or those which user 130 has indicated as a contact within one or more remote social networking sites). The list may, for example, include the name of the contacts and/or a link to each of the contacts (e.g., a belonging profile of the contact). User 130 may select the link to view a user profile of the contact including the belongings associated with the contact within the social graph of belongings. The selection may result in the system accessing and displaying the contact's user profile to user 130.

The system may further access a database of belonging-related posts and retrieve one or more posts associated with the belongings identified as a result of the search query. In one aspect, the system maintains posts generated in response to belonging-related activities of users associated with the social graph of belongings. Belonging-related activities may include activities such as adding a belonging, adding description regarding a belonging, ranking a belonging, writing a review for a belonging, purchasing a belonging, selling a belonging, adding a belonging to a wish list, seeking recommendations or feedback regarding the belonging and/or creating and sharing posts and/or comments regarding a belonging. Posts regarding each belonging may be associated with the specific belonging and stored within the database storing the belonging-related posts.

The system may access the database and retrieve all posts related to the belongings identified as a result of the search query. The system, upon accessing the posts, may determine which of the retrieved posts are associated with the user 130, a contact of user 130 and/or shared with user 130 (e.g., based on the sharing preferences indicated by the contact for the belonging and/or the post). The system may then provide a belonging-related stream of posts to user 130, where the posts are related to belongings corresponding to the item and in one aspect associated with user 130 (e.g., generated by user 130, shared with user 130 and/or associated with a belonging shared with user 130). The belonging-related stream presented to user 130 may further be filtered such that only posts meeting the search criteria (e.g., having reviews) are displayed to the user.

Each belonging-related post may include a link associated with the user creating the post (e.g., contacts of user 130) and a link associated with the belonging the post is related to. The links may be embedded within the post, including the text and/or the image associated with the post. The links may be selectable by user 130 and upon selection may direct the user to a profile related to the link. For example, a link to each user provides access to the belonging profile of the user, while the link to a belonging provides access to the belonging profile of the belonging.

For example, each post may include the name of the user associated with the post. The link to the user may be embedded within the name. User 130 may select the link to view a profile of the user associated with the post, which may be a contact of user 130. The selection may result in the system accessing and displaying the profile (e.g., a contact belonging profile) of the user associated with the post.

Each post may further include a link to the belonging the post is associated with. The link may be embedded within the post, including for example within the image included with the post and/or within the text of the post. For example, where the text of the post includes the name of the belonging, a link may be embedded within the belonging name. User 130 may select the link to view a belonging profile associated with the belonging. The selection of the link may result in the system accessing and displaying a belonging profile associated with the belonging to user 130.

Upon being provided with the list of results, user 130 may, viewing the list of belongings, the contacts associated with the belongings and/or posts associated with belongings, and ask for feedback, reviews and recommendations regarding the item from the contact associated with each belonging and/or post. The user may additionally ask to borrow a belonging from a contact associated with the belonging.

The user may be provided with a graphical user interface including the list. The graphical user interface may allow the user to interact with the list, to select the links embedded within the list to view a profile of a contact or a belonging. User 130 may also generate posts requesting feedback regarding the item and may send the post to contacts within the list and/or contacts associated with the belongings and posts included within the list. Still further, the graphical user interface may display feedback, posts or comments provided by contacts regarding the item (e.g., after the user requests feedback and comments from contacts). For example, the graphical user interface may display a belonging-related stream of posts, comments and feedback regarding the item of interest to user 130.

The user may browse the feedback, posts related to the item, belongings corresponding to the item, and contacts owning the belonging to make a decision regarding purchasing of the belonging. For example, reviews, feedback and experiences of other users with the item of interest to user 130 may provide the user with a helpful indication of whether the item is worth purchasing. Additionally, user 130 may request to try out a belonging of a contact corresponding to the item to gain first hand experience with the item.

FIG. 7 illustrates an exemplary social graph of belongings. As illustrated, the social graph of belongings includes one or more users. Each of the one or more users is associated with one or more belongings. Furthermore, as illustrated, the social graph of belongings may further define associations between the user and other users within the social graph of belonging (i.e., his/her contacts). The exemplary social graph of belongings includes associations among users 1-5 and further defines associations between each of the users 1-5 and one or more belongings.

More specifically, user 1 is associated with user 2, user 4 and user 5. Furthermore, User 1 is associated with belongings including “Camera A”, “Tablet A”, “Mobile Phone” and “Laptop C”. User 2 is illustrated as being associated with user 1, user 3 and user 5, and with belongings including “SKIS” and “MOBILE A”. User 3 is illustrated as being associated with user 2 and user 4, and further with belongings including “CAR B”, “BOOK C” and “JACKET S”. User 4 is illustrated as associate with user 1 and user 3 and belongings including “TV A” and “My Kix”. Finally, User 5 is illustrated as being associated with user 1 and user 2 and with belongings including “TABLET A” and “SUNGLASSES A”.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. In addition, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

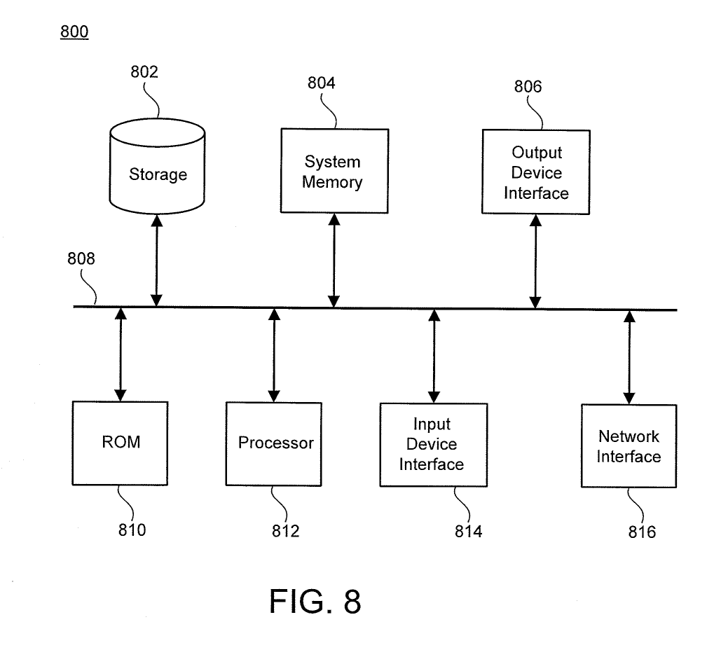

FIG. 8 conceptually illustrates an electronic system with which some implementations of the subject technology are implemented. Electronic system 800 can be a computer, phone, PDA, or any other sort of electronic device. Such an electronic system includes various types of computer readable media and interfaces for various other types of computer readable media. Electronic system 800 includes a bus 808, processing unit(s) 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processing unit(s) 812 with ROM 810, system memory 804, and permanent storage device 802.

From these various memory units, processing unit(s) 812 retrieves instructions to execute and data to process in order to execute the processes of the subject disclosure. The processing unit(s) can be a single processor or a multi-core processor in different implementations.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (such as a magnetic or optical disk and its corresponding disk drive) as permanent storage device 802.

Other implementations use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such a random access memory. System memory 804 stores some of the instructions and data that the processor needs at runtime. In some implementations, the processes of the subject disclosure are stored in system memory 804, permanent storage device 802, and/or ROM 810. For example, the various memory units include instructions for processing multimedia items in accordance with some implementations. From these various memory units, processing unit(s) 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800. Output devices used with output device interface 806 include, for example, printers and display devices, such as cathode ray tubes (CRT) or liquid crystal displays (LCD). Some implementations include devices such as a touchscreen that functions as both input and output devices.

Finally, as shown in FIG. 8, bus 808 also couples electronic system 800 to a network (not shown) through a network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system may be interconnected by any form or medium of digital data communication, e.g., a communication network. While several components or steps are described as being performed by the system, it should be understood that various components and steps may be performed by different systems in communication with one another, e.g., through a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A machine-implemented method for providing a first user with a representation of a belonging according to search criteria, the method comprising:
receiving a request from a first user of one or more users of a system to search a social graph of belongings according to a search criteria, wherein the social graph of belongings defines an association between each of the one or more users and one or more belongings, each of the one or more belongings corresponding to an item;
comparing the one or more belongings associated with each of the one or more users according to the social graph of belongings with the search criteria, wherein the search criteria comprises at least one belonging attribute;
identifying a belonging of the belongings within the social graph of belongings based on the comparison, the belonging having the at least one belonging attribute; and
providing a representation of the belonging for display to the first user, wherein the providing the representation of the belonging comprises providing the first user with access to the belonging profile associated with the belonging.

2. The method of claim 1, wherein the at least one belonging attribute includes one of a belonging name, an item name, the user associated with the belonging maintained within the social graph of belongings, a belonging category, a belonging state or a geographic location of the belonging.

3. The method of claim 1, wherein the comparing each of the one or more belongings within the social graph of belongings with the search criteria comprises:
accessing the belongings within the social graph of belongings, wherein each belonging is associated with a belonging profile comprising belonging attributes; and
comparing the belonging attributes for each of the belongings within the social graph of belongings with the search criteria.

4. The method of claim 3, wherein the belonging attributes include at least one of a belonging name, a belonging image, a belonging sharing preference, a belonging review, a belonging rating, a belonging description, a belonging category, a belonging state, a geographic location of the belonging, or the user associated with the belonging.

5. The method of claim 1, further comprising:
generating a list including the representation of the belonging and at least one of a link to the user associated with the belonging and a link to the belonging,
wherein displaying the belonging to the first user comprises displaying the list to the first user.

6. The method of claim 5, further comprising detecting an indication of a selection of the link to the belonging by the first user, and providing the belonging profile of the belonging for display to the first user in response to detecting the indication of the selection.

7. The method of claim 5, further comprising detecting an indication of a selection of the link to the user associated with the belonging by the first user, and displaying a user profile of the user associated with the belonging to the first user in response to detecting the indication of the selection.

8. The method of claim 1, further comprising:
retrieving one or more posts stored within the system, the one or more posts being associated with belongings within the social graph of belongings;
identifying a post associated with the belonging; and
providing the post for display to the first user, the post including a link to the user associated with the belonging and a link to the belonging.

9. The method of claim 1, further comprising:
identifying contacts of the first user, wherein the contacts of the first user comprise one or more users of the system associated with the first user,
wherein the belonging is associated with one of the contacts of the first user within the social graph of belongings.

10. The method of claim 9, wherein the belonging is further shared with the first user by the one of the contacts of the first user.

11. A system for providing a first user with a list of belongings according to a search criteria, the system comprising:
one or more processors; and
a machine-readable medium comprising instructions stored therein, which when executed by the processors, cause the processors to perform operations comprising:
receiving a request from a first user of one or more users of a system to search a social graph of belongings according to a search criteria, wherein the social graph of belongings defines an association between each of the one or more users and one or more belongings, each of the one or more belongings corresponding to an item;
comparing each of the belongings within the social graph of belongings with the search criteria;
identifying a belonging of the belongings within the social graph of belongings, the belonging meeting the search criteria;
generating a list including a representation of the belonging and at least one of a link to the user associated with the belonging or a link to the belonging; and
providing the list for display to the first user.

12. The system of claim 11, wherein each belonging of the belongings within the social graph of belongings is associated with a belonging profile comprising belonging attributes of the belonging.

13. The system of claim 12, wherein the comparing each of the one or more belongings within the social graph of belongings with the search criteria comprises:
accessing the belongings within the social graph of belongings; and
comparing the belonging attributes for each of the belongings within the social graph of belongings with the search criteria, wherein the search criteria comprises at least one belonging attribute.

14. The system of claim 11, wherein the list further includes one or more posts associated with the belonging.

15. The system of claim 11, the operations further comprising:
identifying one or more users associated with the first user at a remote social networking site, wherein the belonging is associated with one of the one or more users associated with the first user.

16. The system of claim 15, wherein the belonging is shared with the first user by the one of the one or more users associated with the belonging.

17. The system of claim 11, further comprising:
receiving an indication of a selection of the link to the belonging by the first user; and
displaying a belonging profile of the belonging to the first user in response to the selection.

18. The system of claim 11, further comprising receiving an indication of a selection of the link to the user associated with the belonging by the first user, and displaying a user profile of the user associated with the belonging to the first user in response to the selection.

19. A machine-readable medium comprising instructions stored therein, which when executed by a machine, cause the machine to perform operations comprising:
receiving a request from a first user of one or more users of a system to search a social graph of belongings according to a search criteria, wherein the social graph of belongings defines an association between each of the one or more users and one or more belongings, each of the one or more belongings corresponding to an item; wherein each belonging is associated with a belonging profile comprising belonging attributes of the belonging;
comparing the belonging attributes for each of the belongings within the social graph of belongings with the search criteria, wherein the search criteria comprises at least one belonging attribute;
identifying a belonging of the belongings within the social graph of belongings, the belonging having the at least one belonging attribute; and
providing a representation of the belonging for display to the first user.

20. The machine-readable medium of claim 19, wherein the belonging is associated with one of a one or more users associated with the first user at a remote social networking site and further wherein the belonging is shared with the first user by the one of the one or more users.
